(19) United States
(12) Patent Application Publication
(10) Pub. No.: US 2012/0306198 A1
(43) Pub. Date: Dec. 6, 2012

(54) MECHANICAL-HYDRAULIC SUBJECTION SECTIONED COUPLER, TO SEAL WELLS FOR OIL OR GAS

(76) Inventor: Hector Smith Mc Donald Pinedo, Mexico (MX)

(21) Appl. No.: 13/482,219

(22) Filed: May 29, 2012

(30) Foreign Application Priority Data
May 31, 2011 (MX) MX/A/2011/005772

(51) Int. Cl. F16L 21/06

(52) U.S. Cl. 285/323

(57) ABSTRACT

The present invention relates to a subjection sectioned mechanical-hydraulic coupler to seal oil and gas wells including in association: a flange pistons holder; a support bracket attached to the flange pistons holder; a plurality of pistons housed inside the flange pistons holder, the pistons act on a washer plate housed inside the support bracket when a hydraulic fluid is injected through the flange pistons holder; and a tightening crown located inside the support bracket, the tightening crown located under the washer plate, wherein the tightening crown slides down over inside walls of the support bracket when it is pushed by the washer plate.

### FIELD OF THE INVENTION

The present invention refers to the techniques used in the design and manufacture of devices or mechanisms for sealing oil wells in the petroleum exploitation industry and more particularly, it is related to a subjection sectioned mechanical-hydraulic coupler to seal oil or gas wells and to contain the spill of these fuels, avoiding an ecological tragedy.

### BACKGROUND OF THE INVENTION

Crude oil is a natural form of liquid fuels that consist of a complex mixture of hydrocarbons of various molecular weights and other organic liquids, which are found in geological formations below the Earth (underground).

In the most strict sense, the petroleum only includes crude petroleum; however, in practice, a mixture of fluids with other components are extracted, for example, mixtures of liquid-liquid, liquid-gas, liquid-solids, gas-solids, etc.

The petroleum industry is involved in the global processes of exploration, extraction, refining, transportation and marketing of petroleum derivative products; therefore, the geographical location of the extraction oil wells is very important because it affects the transportation costs to the refineries.

In this context, an oil well refers to any ground drilling designed to find and extract the fuel fluid, either petroleum or gaseous hydrocarbons. The older oil wells that are known were drilled in China and they have a depth of approximately 250 m and they operate by using bits attached to bamboo poles.

The first oil wells were pierced by percussion, hammering a tool secured to a cable. Shortly thereafter, the cable tools were replaced by rotary drilling, which allow to drill deeper and in less time. Using this technique, the well is built drilling a hole on the ground of 127 to 914.4 mm in diameter by using a drilling rig which rotates a line or string with a bit at the end. After the drilling is complete, a pipe having a diameter slightly smaller than the drilling pipe is introduced, allowing to seal with cement the rest of the well. This pipe or sleeve provides structural integrity to the work and at the same time allows to isolate it in relation to high pressure areas that may be potentially dangerous. Completing the casing, the drilling can be done at greater depths with a smaller drill bit, repeating then the process with a smaller diameter casing. Modern wells often include from two to five sets of casings of descending diameter to reach great depths.

The resulting material from the drilling is pushed to the surface by the drilling fluid, that after being filtered of impurities and debris is repumped to the well, so is very important to monitor the possible abnormalities in the return fluid to prevent water ram produced when the pressure on the bit increases or decreases suddenly.

The entire process is based on a drilling rig that contains all the necessary equipment for pumping the drilling fluid, lowering and raising the line, to control underground pressures, to extract the rocks of the fluid and to generate in situ the energy required for the operation.

On the other hand, a deep sea platform for the extraction of oil, also known as an oil platform or oil rig, is a structure with installations to drill wells, to extract and process oil and natural gas, to be later sent to the coast. Depending on the circumstances, the platform may be fixed to the bottom of the ocean, may consist of an artificial island, or, may float.

It should be noted that in the exploitation of an underwater oil well, as in the traditional oil wells, the tower is in essence an element to suspend and spin the perforation tube, on its end is located the bit. As the bit penetrates into the Earth's crust, additional pipe sections are added to the drill chain. The force required to penetrate the soil comes from the weight of the drill pipe. To facilitate the elimination of the perforated rock, mud is constantly circulated through the drilling pipe, which flows out through the nozzles located in the bit and rises to the surface through the space between the pipe and the well (the drill bit diameter is slightly larger than the tube). The mud counteracts the pressure to allow oil and gas to continue their paths toward the surface.

Once the drilling has concluded, the well is sealed with cement on a metal cover that is placed in the hole.

By the nature of its operation, the extraction of volatile substances under extreme conditions of pressure and in a hostile environment, means a high risk work environment where accidents and tragedies can happen, which unfortunately occur on a regular basis, such as the explosion of marine oil extraction platforms, causing enormous ocean oil spills.

When we talk about a spill or black tide, we talk about a spill of this hydrocarbon usually due to an accident, largely contaminating the environment, mainly the water and Earth, considerably affecting the plant and animal life, as well as the coasts, if the spill cannot be stopped in time. These spills are extremely expensive and they need to be prevented at all costs, because not only oil is lost, but the contamination cost and the cleaning of the contaminated areas are also very large. In addition, they are very dangerous to the environment, mainly because the affected animals and plants do not have the natural ways to remove the oil from their systems, in addition that the oil penetrates the soil, contaminating it irreparably.

Throughout the history, there have been great tragedies by oil spills, where the most recent occurred in the Gulf of Mexico on Apr. 20, 2010 with the explosion of the oil platform “Deepwater Horizon” in the well “Macondo”, where the extraction well was located approximately 1,500 meters below the sea level in the Gulf of Mexico.

In the specific case of oil well “Macondo”, the well was already cemented and ready for the next phase of drilling; however, as of today the causes of the explosion of the underwater platform are not well known, but the truth is that it happened and originated a serious problem, since, due to the depth of the well, the operation to seal the well became a difficult task by the adverse depth conditions on which the upper part of the referred well is located, as well as the mechanisms or devices and procedures known in the state of the art could not do it.

In this context, in the state of the art are known various procedures and devices for sealing oil wells, such as the case of Mexican Patent No. 49366 which refers to the improvements of a method to seal the ring that surrounds the tubing in hole drilling wells. However, this procedure has the disadvantage that is used in oil wells on the ground in such a way that its implementation in a submerge well cannot be implemented.

Also, is the Mexican Patent No. 138726 which refers to improvements in a burst suppressor for oil wells, which is adapted to seal with a tube or other object a well hole or to close the same in the absence of any object in the well hole, where such improvements include an elastic sealing element that has a curved internal surface adapted to be attached to a tube or similar in a well hole; a rigid retention plate mounted with the sealing element and that has a curved inner surface which conforms in general with the curved inside surface of the sealing element; devices to push the sealant element radially inward in relation to the internal curved surface of the plate, to make a seal with a tube or similar in a well bore or with itself to close a well hole, and a first anti-extrusion device mounted with the plate and moving radially in connection therewith, in response to the radial motion toward the inside of the sealing element to connect parts of the tube or object into the wall hole or other anti-extrusion devices in the absence of any object in the wall hole, to inhibit the extrusion of the sealing element lengthwise in the radial area of inward of the plate when the fluid pressure is over the sealing element.

Also Mexican Patent No. 151228 describes a device to control the spill of maritime oil wells, which comprises a camera with open bottom end and closed top end by a cap tilted up from the periphery toward the center; a plurality of valves arranged in a line near the periphery of such cover, these valves being directed upward and communicating with two driving tubes; a general valve located in the center or highest part of such cover, such general valve being directed upwards through a vertical pipe; a side derivation located at a predetermined height of the general tube valve; the derivation having a valve to control the flow of liquid hydrocarbons; a pressure shock absorber located in the tube at a height greater than that which is in this derivation, to separate and prevent the passage of liquid hydrocarbons that are forced via the side derivation as allows the passage of gas; a lighter directed upwards above the mentioned pressure shock absorber; and a sealing system under the lower edge of the chamber to seal the border with respect to the sea bed around the leak.

On the other hand, the Mexican Patent No. 155176 describes the improvements in an annular sealing device to prevent bursting on drilling for oil or gas equipments, which comprises a lower housing, a top housing; an elastic sealing ring placed between them; and a piston to operate the seal; characterized because the inner surface of the upper housing has a spherical surface; the inner surface of the lower housing has a spherical surface, where the spherical surfaces of the top housing and the lower housing have a concentric relationship; and the elastic seal ring includes spherical top and bottom surfaces for co-acting with the surfaces on the top and lower housings, respectively, responding to the linking of the seal of the piston to be operated.

However, the prior art patent documents found have the disadvantage that cannot be used at the great depths in the sea bed.

As a consequence of the above, it has been sought to overcome the disadvantage found in the state of the art through the development of a subjection sectioned mechanical-hydraulic coupler that allows to seal an oil well and contain the oil spill preventing an ecological disaster.

### OBJECTS OF THE INVENTION

Taking into account the disadvantages of the previous art technique, it is an object of the present invention to provide a subjection sectioned mechanical-hydraulic coupler, of extremely simple design and construction, but highly efficient to seal oil wells and contain oil spills.

It is still another object of the present invention to provide a subjection sectioned mechanical-hydraulic coupler that allows to carry out the sealing operation of the metal-metal type in a watertight manner.

Another object of the present invention is to provide a subjection sectioned mechanical-hydraulic coupler that can be installed in a matter of seconds under adverse conditions that prevail in the bottom of the sea, as well as in any other situation, with a minimum required time.

It is another object of the present invention to provide a subjection sectioned mechanical-hydraulic coupler, which because of its design and construction, can be directly coupled around the neck of a flange of a LMRP containment system (Lower Marine Riser Package), or that can be attached to other types of devices, such as a security valves system or cutting blades system.

### BRIEF DESCRIPTION OF THE INVENTION

It has been found that subjection sectioned mechanical-hydraulic coupler according to the present invention is highly efficient to hermetic seal leaks in an oil or gas well, since because of its design and construction, can seal metal-metal and ensure zero leakage once the well has been repaired. The subjection sectioned mechanical-hydraulic coupler comprises in association: a flange pistons holder which has a configuration that allows to attach to a support bracket; a plurality of pistons preferably cylindrical in shape that act on a washer plate housed in the interior of the support bracket when a hydraulic fluid is injected through the flange pistons holder; and a tightening crown located in the interior of the support bracket, located under the washer plate, where the tightening crown slides down inside the walls of the support bracket when it is pushed by the washer plate, and the tightening crown presents a configuration that allows to attach it to a conical flange, which in turn is fixed preferably to a conical flange fixed in a containment system LMRP (Lower Marine Riser Package), where such a conical flange must have a configuration that allows the coupling of the subjection sectioned mechanical-hydraulic coupler to achieve a watertight seal of metal-metal.

Once the subjection sectioned mechanical-hydraulic coupler of the present invention and the conical flange, the latter is fixed by using screws and nuts to a flange which in turn is fixed attached in the LMRP containment system, to later insert a tube through the center hole of the flange pistons holder and injecting hydraulic fluid through the holes located at the top face of the flange pistons holder by exerting pressure on the pistons, which in turn acts on the washer plate that pushes down the sectioned tightening crown, which slides down on the internal walls of the support bracket until the projection located on the tightening crown is inserted into the neck of the conical flange, hermetically closing the leak and the well hole. In this mode, the subjection sectioned mechanical-hydraulic coupler of the present invention can be removed.

In an additional embodiment, the coupling of the subjection sectioned mechanical-hydraulic coupler of the present invention, this may be securely anchored to the LMRP containment system, and therefore after injecting the hydraulic fluid through one of the holes on the flange pistons holder, such that the leak of the well hole is sealed, on the remaining holes a hardening cement is injected.

### BRIEF DESCRIPTION OF THE FIGURES

The novel aspects that are considered characteristic of the present invention, will be established with particularity in the attached claims. However, the invention itself, by its organization and its method of operation, together with other objects and advantages of the same, will be better understood with the following detailed description of certain embodiments, when read in relation to the attached drawings, in which:

FIG. 1 is a perspective front and top view of a subjection sectioned mechanical-hydraulic coupler for sealing wells of oil or gas, built in accordance with the principles of a particularly specific mode of the present invention.

FIG. 2 is an exploded perspective view of the subjection sectioned mechanical-hydraulic coupler of FIG. 1, showing all the elements that conform it.

FIG. 3 is a longitudinal cross-sectional view taken along the line X-X′ of the subjection sectioned mechanical-hydraulic coupler striped of FIG. 1.

FIG. 4 is a perspective front and top view of the flange pistons holder, which is part of the subjection sectioned mechanical-hydraulic coupler of the present invention.

FIG. 5 is a cross-sectional view taken along the line A-A of the flange pistons holder of FIG. 4.

FIG. 6 is a perspective front and top view of the support bracket which is part of the subjection sectioned mechanical-hydraulic coupler of the present invention.

FIG. 7 is a cross-sectional view taken along line B-B of the support bracket of FIG. 6.

FIG. 8 is a perspective front and top view of a washer plate that it is part of the subjection sectioned mechanical-hydraulic coupler of the present invention.

FIG. 9 is a cross-sectional view taken along the line C-C′ of the washer plate of FIG. 8.

FIG. 10 is a perspective front and top view of the tightening crown that is part of the subjection sectioned mechanical-hydraulic coupler of the present invention, to show the sectioning of the tightening crown.

FIG. 11 is a cross-sectional view taken along line D-D′ of the tightening crown of FIG. 10.

FIG. 12 is a cross-sectional view of the subjection sectioned mechanical-hydraulic coupler, which is attached to the conical flange that is fixed to the LMRP containment system, before injecting hydraulic fluid.

FIG. 13 is a cross-sectional view of the subjection sectioned mechanical-hydraulic coupler, which is attached to the conical flange that is fixed to the LMRP containment system, after injecting hydraulic fluid.

### DETAILED DESCRIPTION OF THE INVENTION

It has been found that the subjection sectioned mechanical-hydraulic coupler of the present invention is highly efficient for hermetic sealing oil wells, managing to effectively contain oil spills, since due to its design and construction, as well as materials with which it is manufactured, allows to perform a metal-metal type sealing and achieve zero oil leakage. As mentioned in the previous background chapter, the procedures and mechanisms to block bursts and prevent spills in oil wells found at the state of the art, presented the great disadvantage of not being ideal for sealing underwater wells, since the undersea conditions prevent the installation, not being the same with the subjection sectioned mechanical-hydraulic coupler as described and claimed in the present invention as being installed in a fast and perfect manner.

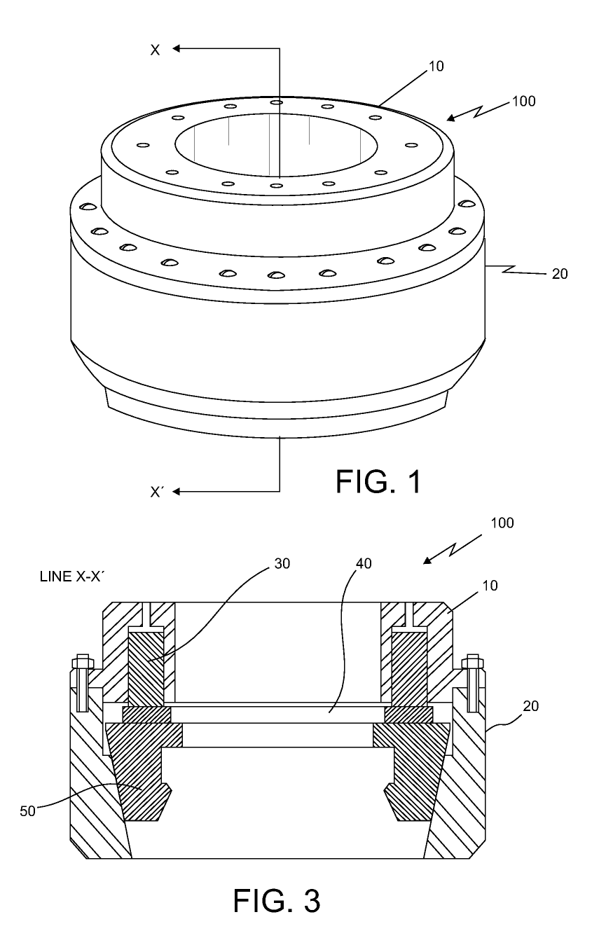

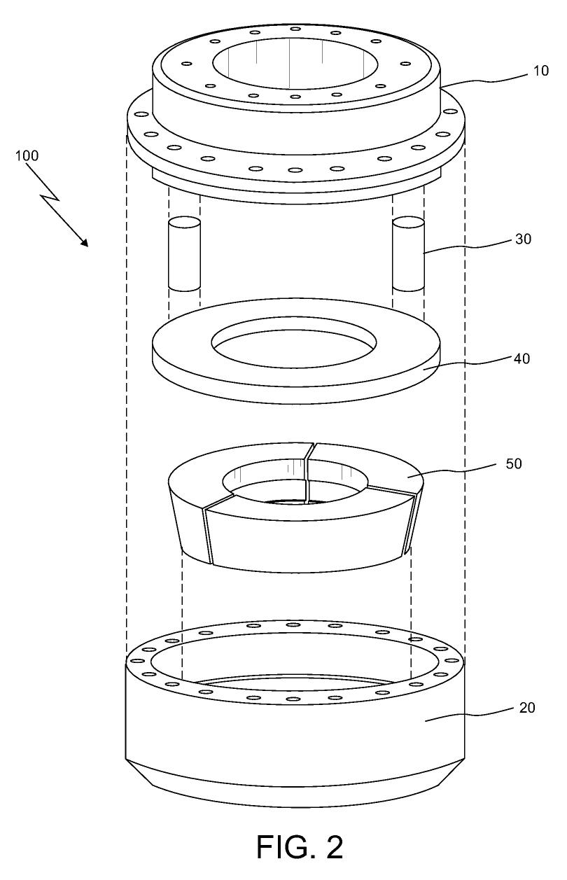

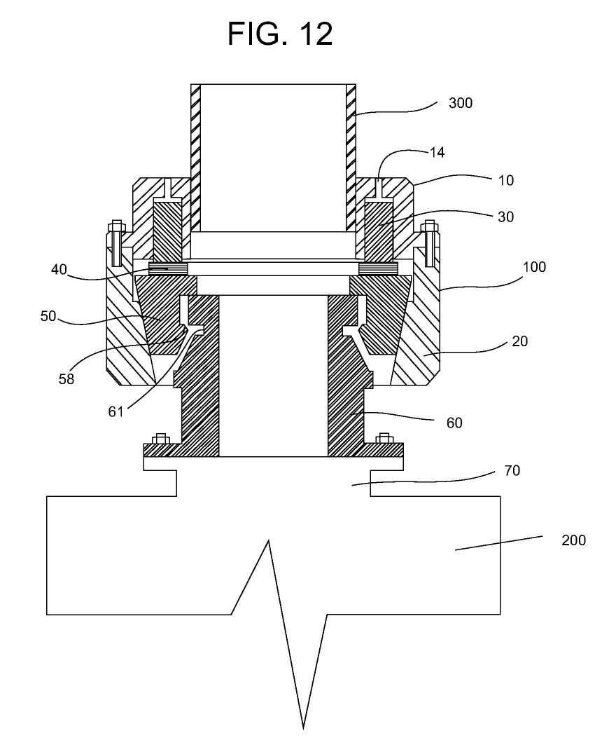

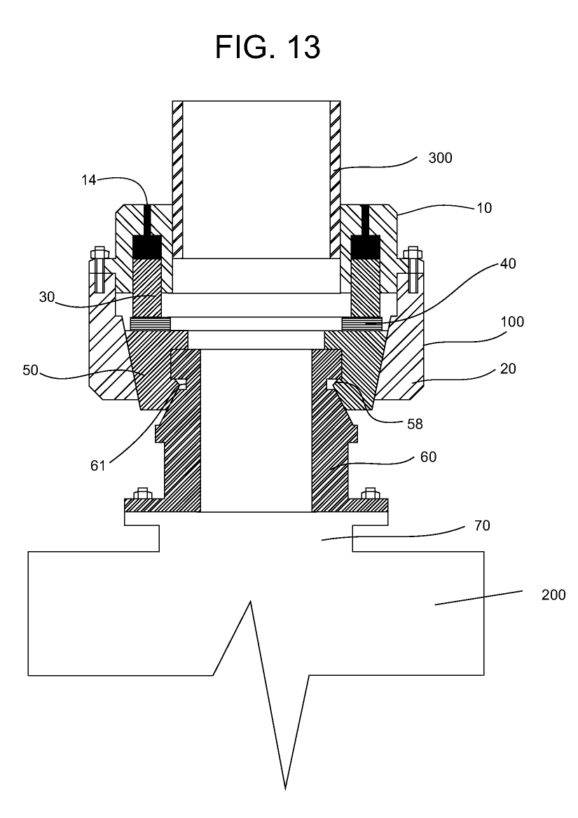

Now referring to drawings that accompanied, and more specifically to FIGS. 1 to 3 of the same, which show a subjection sectioned mechanical-hydraulic coupler 100 to seal leaks in oil or gas wells, built in accordance by a specific embodiment of the present invention, which, in general terms includes in association: a flange pistons holder 10 which has a configuration that allows to attach to a support bracket 20; a plurality of pistons 30 preferably cylindrical in shape that are placed on the interior of the flange pistons holder, which act on a washer plate 40 housed in the interior of the support bracket 20 when a hydraulic fluid is injected through the flange pistons holder 10; and a tightening crown 50 located in the interior of the support bracket 20, located under the washer plate 40. The tightening crown 50 slides down inside the walls of the support bracket 20 when it is pushed by the washer plate 40, the tightening crown 50 presents a configuration that allows to attach it to a conical flange 60 (See FIGS. 12 and 13), which in turn is fixed preferably to a conical flange 70 fixed in a containment system LMRP (Lower Marine Riser Package) 200, where such conical flange 70 must have a configuration that allows the coupling of the subjection sectioned mechanical-hydraulic coupler 100 to achieve a watertight seal of metal-metal.

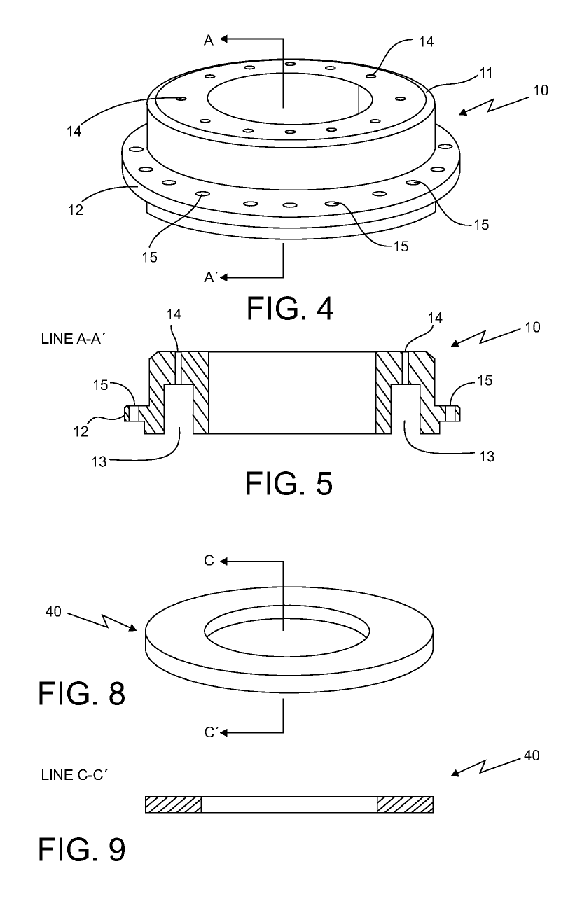

In FIGS. 4 and 5 of the accompanying drawings, can be seen the flange pistons holder 10, which comprises a body 11 preferably having a ring-shaped and includes a projection 12 located on the perimeter and that extends away from the outer surface of the body 11. The body 11 includes in the entire lower face a plurality of housings 13 preferably in cylindrical shape, equally disposed and separated from each other, which are extend ascending from the lower face of the body 11 toward the interior of the body until reaching a depth that goes beyond the half of the thickness of the body 11, where the diameters of the housings 13 are slightly larger than the diameter of the pistons 30, such that these pistons 30 may be accommodated under pressure inside the housings 13.

In addition, the body 11 includes in the upper face a plurality of holes 14, distributed and separated equally across each other, such that they coincide with the distribution of the housings 13, in addition to be axially arranged with respect to the housings 13, such that these holes 14 are located in a concentric relationship with the housings 13. Through the holes 14 the hydraulic fluid is injected which pushes the pistons 30 which, in turn, push down the washer plate 40.

The projection 12 includes centrally located over its entire surface a plurality of openings 15, distributed and separated equidistantly from each other, whose function is to receive a plurality of fasteners, preferably screws and nuts that allow it to fasten flange pistons holder 10 to the support bracket 20.

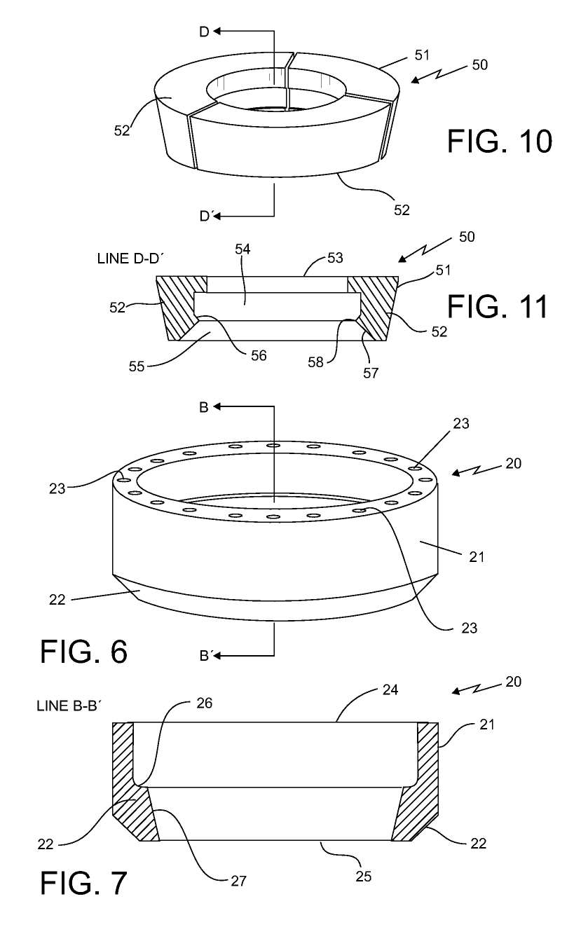

In regard to FIGS. 6 and 7 of the accompanying drawings, they show the support bracket 20, which comprises a body 21 preferably ring-shaped which includes a chamfer edge 22 at its lower end and a plurality of apertures 23 on its upper end, distributed and separated equidistantly from each other, wherein the apertures match with the openings 15 locates on the projection 12 of the flange pistons holder 10, such that the support bracket 20 may be firmly secured to the flange pistons holder 10.

The central hole of the body 21 includes two different diameters, 24 and 25 respectively, throughout the thickness of the body 21, of which, the first diameter 24 ranges from the upper end of the body 21 until approximately half the thickness and the second diameter 25 ranging from half of the thickness to the lower end of the body 21, where the first diameter 21 is larger than the second diameter 25, forming a step 26 between said first and second diameters, 24 and 25 respectively. The second diameter 25 presents a chamfer 27, which makes the second diameter 25 to be smaller towards the lower end of the body 21, as can be seen in FIG. 7.

Now referring more specifically to FIGS. 8 and 9 of the accompanying drawings, they show the washer plate 40 which has the configuration of a washer, whose hole has a diameter approximately equal to the inside diameter of the flange piston holder 10.

Referring now to FIGS. 10 and 11, they show a tightening crown 50 having a body 51 of preferably an inverted frustum-conical shape and centrally perforated, which comprises a plurality of sections 52, made preferably in the described embodiment by three sections, each one of them cut to 120°, whose walls converge each with respect to the others. The central hole of the body 51 includes different diameters in the entire thickness of the body 51: a first diameter 53 that occupies the upper portion; a second diameter 54 that occupies the middle portion of the thickness of the body 51, wherein the second diameter 54 is larger than the first diameter 53; and a third diameter 55 that occupies the lower portion. The second diameter 54 includes a first inclination 56 that projects inward with an angle between 45° and 65°, preferably a 60° angle; and the third diameter includes a second inclination 57, as a continuation and opposed to the inclination 56, which is projected outward forming a ridge 58 between the second diameter 54 and the third diameter 55.

Going back to FIG. 3 of the drawings, it can be seen how it is assembled to enter in function or operation the subjection sectioned mechanical-hydraulic coupler 100 which is described and claimed in the specific embodiment of the present invention, the sectioned tightening crown 50 is inserted inside the support bracket 20, and then over the sectioned tightening crown 50 is placed the washer plate 40. In the housings 13 of the flange pistons holder 10 are inserted the pistons 30 and the flange pistons holder is placed and fixed to the support bracket 20 by suing screws. Once the subjection sectioned mechanical-hydraulic coupler 100 has been assembled, the conical flange 60 is inserted and attached.

With specific reference to FIGS. 12 and 13 of the accompanying drawings, they show the coupling of the subjection sectioned mechanical-hydraulic coupler 100 of the present invention, in where the assembly of the mechanical-hydraulic coupler 100 and the conical flange 60 are fixed with screws and nuts to the flange 70, which in turn is fixed to the LMRP 200 containment system. Then a tube 300 is inserted through the flange piston holder 10 and the hydraulic fluid is injected through the holes 14 located on the top face of the flange piston holder 10 exerting pressure on the pistons 30 and, which in turn act on the washer plate 40 pushing down the sectioned tightening crown 50, slides down on the internal walls of the support bracket 20 until the projection 58 located on the tightening crown 50 is inserted into the neck 61 of the conical flange 60, as is indicated by FIG. 13, until completely closing, and therefore, block the leak from the well hole (not shown in the pictures) producing a metal-metal sealing. In this embodiment, the subjection sectioned mechanical-hydraulic coupler 100 of the present invention can be removed from the conical flange 60.

In an additional embodiment the coupling of the subjection sectioned mechanical-hydraulic coupler 100 of the present invention, this may be securely anchored to the conical flange 60 and therefore to the LMRP containment system 200, and therefore should be injected the fluid just in some of the holes 14 of the flange pistons holder 10 and to the remaining holes 14 a cement hardening agent is injected.

It is obvious to any person skilled in the art, that embodiments of the subjection sectioned mechanical-hydraulic coupler 100 for sealing oil or gas wells described and illustrated in the accompanying drawings, should be considered only as illustrative but not limitative of the present invention, since numerous consideration changes are possible in its details but without departing from the true scope of the invention, such as the shape and number of the essential elements, the number of sections of the tightening crown, the method of injecting hydraulic fluid, among others. Therefore, the present invention shall not be considered as restricted, except by requiring the previous technique and the spirit of the attached claims.

1. A subjection sectioned mechanical-hydraulic coupler to seal oil and gas wells comprising in association:
a flange pistons holder;
a support bracket attached to the flange pistons holder;
a plurality of pistons housed inside the flange pistons holder, the pistons act on a washer plate housed inside the support bracket when a hydraulic fluid is injected through the flange pistons holder; and
a tightening crown located inside the support bracket, the tightening crown located under the washer plate, wherein the tightening crown slides down over inside walls of the support bracket when is pushed by the washer plate.

2. The subjection sectioned mechanical-hydraulic coupler according to claim 1, wherein the flange pistons holder includes an annular body and a projection located on a perimeter of the annular body extending away from the outer surface of the annular body, the annular body includes in an entire lower face a plurality of housings equally disposed and separated from each other, the housings are extended ascending from the lower face of the annular body toward an interior of the annular body until reaching a depth that goes beyond half of a thickness of the annular body, wherein diameters of the housings are slightly larger than diameters of the pistons, the pistons are accommodated under pressure inside the housings.

3. The subjection sectioned mechanical-hydraulic coupler according to claim 2, wherein the annular body includes in an entire upper face a plurality of holes equally distributed and separated from each other, the holes coincide with the housings, the holes are axially arranged with respect to the housings, holes are located in a concentric relationship with the housings.

4. The subjection sectioned mechanical-hydraulic coupler according to claim 2, wherein the projection includes centrally located over an entire surface a plurality of openings, the openings are equally distributed and separated from each other, the openings receive a plurality of fasteners to fasten the flange pistons holder to the support bracket.

5. The subjection sectioned mechanical-hydraulic coupler according to claim 1, wherein the support bracket comprises a ring shaped body including a chamfer edge on a lower end and a plurality of apertures on an upper end equally distributed and separated from each other, wherein the apertures match with the openings located on the projection of the flange pistons holder, the support bracket is firmly secured to the flange pistons holder.

6. The subjection sectioned mechanical-hydraulic coupler according to claim 5, wherein the central hole of the annular body includes a first diameter and a second diameter throughout the thickness of the annular body, the first diameter goes from the upper end of the annular body until about half the thickness of the annular body, and the second diameter goes from the half of the thickness to the lower end of the annular body, the first diameter is larger than the second diameter forming a step between the first and the second diameters, the second diameter includes a chamfer producing the second diameter to be smaller towards the lower end of the annular body.

7. The subjection sectioned mechanical-hydraulic coupler according to claim 1, wherein the washer plate is a washer with a hole having a diameter approximately equal to an inside diameter of the flange piston holder.

8. The subjection sectioned mechanical-hydraulic coupler according to claim 1, wherein the tightening crown includes a body having an inverted frustum-conical shape and includes a central hole, the body comprises a plurality of sections, the central hole of the body includes a first diameter located on an upper portion; a second diameter located on a middle portion of the thickness of the body, the second diameter is larger than the first diameter; and a third diameter located at a lower portion, the second diameter includes a first inclination that projects inward with an angle between 45° and 65°, and the third diameter includes a second inclination as a continuation and opposed to the first inclination projecting outward forming a ridge between the second diameter and the third diameter.

9. The subjection sectioned mechanical-hydraulic coupler according to claim 8, wherein the first inclination of the second diameter is projected outward at an angle of 60°.

10. The subjection sectioned mechanical-hydraulic coupler according to claim 8, wherein the tightening crown comprises three sections, each section is cut to a 120° angle and lateral walls of the section converge together.

11. The subjection sectioned mechanical-hydraulic coupler according to claim 1, wherein during operation the tightening crown is inserted inside the support bracket, and then the washer plate is placed over the tightening crown, in the housings of the flange pistons holder the pistons are inserted, and the flange pistons holder is placed and fixed to the support bracket by suing fasteners, when the subjection sectioned mechanical-hydraulic coupler is assembled then the conical flange is inserted and attached, the conical flange is fixed to a flange located on a containment system LMRP (Lower Marine Riser Package) to obtain a metal-metal hermetic seal.

12. The subjection sectioned mechanical-hydraulic coupler according to claim 11, wherein the hydraulic fluid is injected through the holes located on the top face of the flange piston holder exerting pressure over the pistons, the pistons act on the washer plate pushing down the tightening crown, the tightening crown slides down on the internal walls of the support bracket until the projection located on the tightening crown is inserted into a neck on the conical flange until completely closing the well hole.

13. The subjection sectioned mechanical-hydraulic coupler according to claim 1, wherein the subjection sectioned mechanical-hydraulic coupler is removable.

14. The subjection sectioned mechanical-hydraulic coupler according to claim 1, wherein the subjection sectioned mechanical-hydraulic coupler is fixed to the conical flange and a containment system LMRP, the fluid is injected just in some of the holes of the flange pistons holder and to the remaining holes a cement hardening agent is injected.
